(19) United States
(12) Patent Application Publication
(10) Pub. No.: US 2005/0053755 A1
(43) Pub. Date: Mar. 10, 2005

(54) Vacuum insulation panel and method

(75) Inventor: Ralph Markey, Columbus, NC (US)

Correspondence Address: BAKER & HOSTETLER LLP;Washington Square, Suite 1100, 1050 Connecticut Avenue, N.W., WASHINGTON, DC, 20036, US

(73) Assignee: KENDRO LABORATORY PRODUCTS, LP

(21) Appl. No.: 10/657,235

(22) Filed: Sep. 9, 2003

(51) Int. Cl. B32B 1/04

(52) U.S. Cl. 428/69; 428/137

(57) ABSTRACT

A vacuum insulated panel and method includes a port hole and/or side or corner features such as indentations on a panel. The port hole and/or indentations permit a passageway for wires, conduits, or other items through the panel.

### FIELD OF THE INVENTION

The invention pertains generally to the field of insulation, such as for example insulation used in appliances such as freezers. More particularly, the invention pertains to vacuum insulation panels and methods.

### BACKGROUND OF THE INVENTION

There are many instances for example in industry where thin but effective insulation is desired. In the case of environmental units such as both consumer and industrial refrigerators and freezers, insulation is generally put in portions of the units surrounding the inside cabinet in order to reduce energy transfer to or from interior of the unit. For example, in the case of ultra low temperature freezers, insulation is generally provided between the inner cabinet wall and the outer housing wall of various parts of the unit. The insulation may be provided around the inside of the three side walls, the hinged front door and/or the top and bottom of the unit.

One method in the prior art for providing such insulation is to “charge” or introduce foam polyurethane material to fill the space between the inner cabinet wall and the outer housing wall. This method is sometimes satisfactory, however, in many instances a relatively thick spacing is required to provide sufficient foam to accomplish the R-factor as desired. For example, in the case of some ultra low temperature freezers, a five inch thick spacing filled with the polyurethane foam may be required between the inner cabinet wall and the outer housing wall. It is desirable to reduce this thickness, so that a freezer unit of a given volume will have a smaller footprint. As the thickness of the insulation can be reduced, the footprint of the unit becomes smaller which is typically desirable to the end user.

One approach to overcoming the above wall thickness disadvantages has been the introduction of a product called a vacuum insulated panel. One type of known vacuum insulated panel is manufactured in the following manner. First, a block of a core material having a rectangular outline and a specified thickness is provided. The core block is typically made of silica or polyester, which have desirable properties with respect to minimizing or substantially elimidating outgassing or moisture from the core. The core is then surrounded by a thin film pouch. The pouch is typically a multilayer film having for example 5 to 10 layers, and may be manufactured from mylar, polyester or other suitable polybarrier material. The pouch is generally formed of two sheets each having the same shape which generally corresponds to the rectangular perimeter shape of the core, but has an overlap region so that the sheets may touch and overlap each other completely around the perimeter edge of the core.

Next, the assembly including the core and the pouch are processed in a very low pressure or essentially vacuum environment and the two sheets that form the pouch are sealed together completely around the periphery of the core to form an envelope surrounding the core. For convenience, the pouch may have typically one or two sides of the four sides pre-sealed to each other and the other remaining edges, typically one or two sides, are sealed in the vacuum environment.

The sheets forming the pouch are sealed to each other typically by being heat pressed or laminated. A heating element corresponding in shape to the areas to be sealed is pressed down around the perimeter, or alternatively some form of heated roller may be rolled along the area to be sealed.

When the sealing under vacuum is complete, the now-finished vacuum insulated panel, including the core and the surrounding envelope, is removed from the vacuum environment. Atmospheric pressure causes the envelope to be firmly pressed against the core, so that finished vacuum insulating panel has substantially the shape of the core, with a small sealing lip protruding around the some or all of the periphery where sealing of the two sheets of the pouch was performed.

Conventional vacuum insulated panels have been manufactured so that in plan view they have a rectangular configuration. Some panels typically used in industry are one half inch to one inch thick and generally, on the order of one to three in length foot by one to three foot in width.

These panels can then be placed during manufacture of a freezer between the inner chamber wall and outer housing wall of the freezer to provide insulation. Typically, the panels are supported between the aforementioned walls of the freezer during manufacture, and the foamed-in-place urethane insulation is then foamed into the remaining interior space to fill the remaining interior space and support the vacuum insulated panel in the space.

In the case of using vacuum insulated panels in the side wall of a freezer, several panels are generally required to fully cover the area of each side wall. Manufacturing considerations restrict the size of panel that can economically be manufactured, so that in the case of for example, a four foot by six foot cabinet wall, an array of panels generally needs to be installed. Since the panels are rectangular in outline, for a two foot by six foot wall an array of for example six rectangular panels may be joined edge to edge to cover the side wall region. Typically the panels are abutting each other and joined together with tape.

A disadvantage of the above described of vacuum insulated panels is that the array of adjoining vacuum insulated panels do not provide any aperture or conduit through the insulation. Often it is desirable to have such an aperture or conduit somewhere in the sidewall of the freezer to permit for example, diagnostic wiring or material-carrying conduits for a backup cooling system. However, in the above described prior art arrangements, it is not possible to provide such a conduit in a side wall that uses the array of conventional vacuum insulated panels, because drilling a hole through the panels would break the vacuum of the panel being drilled.

### SUMMARY OF THE INVENTION

Te present invention provides a vacuum insulation panel and method that can overcome the above noted disadvantages at least to some extent.

In accordance with one embodiment of the present invention, a vacuum insulated panel comprises a core having a perimeter and an aperture extending through the core, and a film envelope surrounding the core having a hole located adjacent the aperture of the core, the envelope being sealed around the aperture of the core.

In accordance with another embodiment of the present invention, a vacuum insulated panel comprises a core having a substantially rectangular overall perimeter, and a indentation provided on at least one side of the overall perimeter of the core, and a film envelope surrounding the core having a perimeter including an indentation.

In accordance with yet another embodiment of the present invention, a vacuum insulated panel comprises a core having a substantially rectangular overall perimeter and a beveled region forming one corner as a beveled corner, and an envelope surrounding the core and having a perimeter with a beveled region.

A method pertaining to these panels and a freezer having these panels are other aspects of the invention.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a slightly perspective plan view showing four configurations of vacuum insulated panels according to four preferred embodiments of the invention, respectively.

FIG. 2 is a partially cross-sectional view showing a vacuum insulated panel having a tube being passed there through the accordance with one preferred embodiment illustrated in FIG. 1.

FIG. 3 is a cross-sectional view showing a portion of a side wall of the freezer according to the preferred embodiment of the invention.

FIG. 4 is a perspective layout view showing array of vacuum insulated panels used in side walls of a freezer.

### DETAILED DESCRIPTION

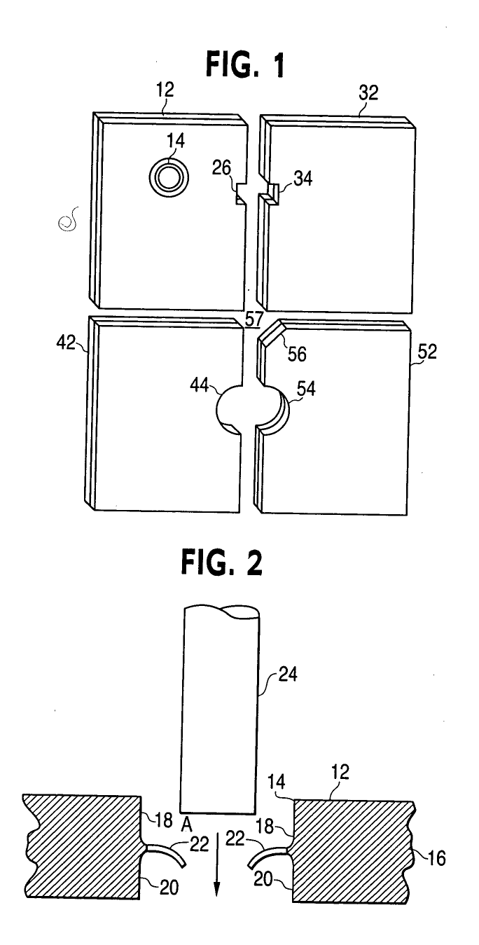

The present invention provides improved vacuum insulated panels and methods. FIG. 1 illustrates four different exemplary panels according to various embodiments of the present invention. A panel 12 is illustrated which includes a port hole 14 extending through the panel 12 and a side notch 26 provided at one edge of the panel 12.

The port hole 14 is manufactured by providing the core 16 of the panel 12 with a corresponding hole therethrough, and by providing holes in the film sheets 18 and 20 at the same location. The film sheets 18 and 20 are sealed in a circle surrounding to the port hole 14 during manufacture. FIG. 2 is a cross-sectional view depicting the panel 12 having the port hole 14. It will be appreciated that the core 16 is surrounded by an upper film sheet 18 and a lower film sheet 20. The core 16 is made of silica, polyester on other suitable material. The core 16 is surrounded by an envelope made from the two film sheets 18 and 20. The film sheets 18 and 20 are made of multilayer film having for example 5 to 10 layers, made of mylar, polyester or other suitable polybarrier material. The two sheets 18 and 20 have been thermally or otherwise bonded together to form a lip seal region 22 as shown.

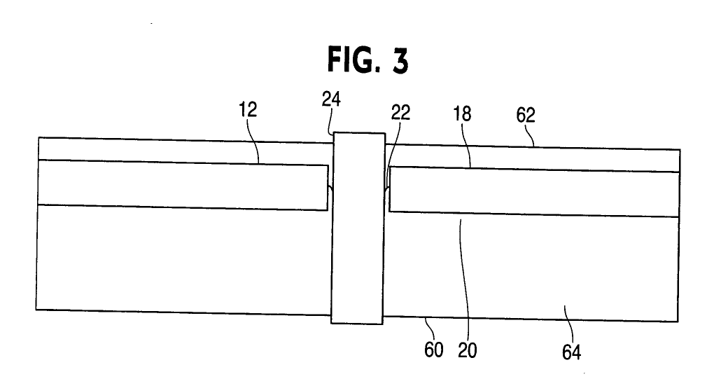

Further as shown in FIG. 2, the port hole 14 accepts a protective tube 24 which can be inserted through the port hole 14 and which provides a passage for electrical wires, fluid conduits, or other items. The inner diameter of the port hole 14 and the outer diameter of the tube 24, are preferably selected to be very close to each other, with only a small tolerance to permit insertion of the tube 24 into the port hole 14. Selecting a small tolerance reduces the gap area between the port hole 14 and the tube 24, which is an area that later becomes filled with the foam insulation 64 as shown in FIG. 3, and discussed further below. Since the foam insulation 64 is less effective at insulating than the vacuum insulated panel 12, it is desirable to keep this gap small.

Returning to FIG. 1, the panel 12 is shown also having a side indentation feature 26, which is shown having two shoulders. This indentation feature 26 can be manufactured by providing an indented region (having the indented shape with the shoulders) at the peripheral edge of the core, and by cutting the upper and lower sheets 18 and 20 so their edges each have a generally corresponding indented region and then sealing these edges together.

It will be appreciated that the vacuum insulated panel 12 thus has both a penetrating port hole 14 and a shaped side forming the indentation 26. To produce these features, the core 16 is first produced having the desired features 14 and 26, and both the upper and lower film sheets 18 and 20 are also produced with the desired shapes. Further, the sealing apparatus that is used is adapted to form the circular seal around the port hole 14 and also form a seal with two shoulders in an indentation shape to form the indentation 26.

Continuing with FIG. 1, a vacuum insulated panel 32 is illustrated having an indentation region 34 which is similar in structure to the indentation region 26 previously described but facing the other way. Where it is desired to provide a passageway through a panel array at a location that is adjoining of the sides of two panels, it will be appreciated that panels 12 and 32 having opposed regions, such as indentation region 26 and indentation region 34 can be abutted next to each other to provide a single combined passageway defined by the indentations 26 and 34. One common way of holding adjoining panels together during manufacture is to tape the adjoining panels along their edges. In such a case, the tape will be omitted or cutaway from the area of the passageway caused by indentations 26 and 34.

Another vacuum insulated panel 42 is illustrated having an indentation region 44. This indentation region 44 is semi-circular in shape, but otherwise is similar to indentation region 26.

Another vacuum insulated panel 52 is shown having an indentation region 54 and a beveled corner 56, the indentation region 54 is substantially the same as indentation region 44 but facing the other way.

Thus the two panels 42 and 52 can be assembled abutting together with the indentation regions 44 and 54 opposing each other, to create a circular passageway through the combined indentation regions 44 and 54. As described with respect to the indentation regions 26 and 34 above, if tape is used to hold the panels 42 and 52 in abutting relationship during manufacture, the tape can be omitted or cutaway in the region of the aperture created by indentation regions 44 and 54 to permit passage for the desired items.

Vacuum insulated panel 52 also features a beveled corner 56 as shown. This beveled corner 56 is formed by providing a beveled corner having the illustrated shape at a corner of the core of the vacuum insulated panel 52. Further, the two sheets forming the surrounding envelope also have a corresponding corner and the sealing device is configured to seal this beveled corner. In some instances it may be preferable to leave the sheet members having a squared corner and after they are sealed the combined flap in the region of the beveled corner 56 can simply be folded out of the way.

If the four panels 12, 32, 42, and 52 illustrated in FIG. 1 are arranged in an array as shown, it will be appreciated that the beveled corner 56 would provide a triangular passageway through which items could be placed. If a larger passageway 57 is desired, a beveled corner similar to beveled corner 56 could be provided in the adjacent corners of the panels 12, 32, and/or 42 thus providing a larger overall aperture. In such an example, if a bevel is placed in the upper right corner of the panel 42, a larger triangular aperture would be created. If the adjacent corners of all four panels 12, 32, 42 and 52 had a bevel such as bevel 56, a square aperture would be provided.

FIG. 3 is a cross-sectional view of a side wall of an item such as for example an ultra low temperature freezer using a vacuum insulated panel such as vacuum insulated panel 12. The vacuum insulated panel 12 is similar to that shown in FIGS. 1 and 2 and includes an upper sheet 18 a lower sheet 20 and a seal flap 22. A tube 24 has been inserted through the aperture. The tube 22 also extends through the entire side of the ULT cabinet which includes an inner wall of the chamber 60 and an outer wall 62 of the cabinet. Typically, these walls 60 and 62 are each sheet metal such as steel or aluminum, sheet plastic or a similar material.

Foamed-in-place insulation 64 fills at least substantially all of the space between the inner wall 60 and the outer wall 62 as shown, except for the space taken up by the vacuum insulated panel 12. It will be appreciated that by this arrangement the tube 24 provides a passageway between the inner chamber and the outside of the cabinet. This passage is desirable to accommodate for example wiring associated with diagnostic equipment, and/or conduits for carrying liquid or gas materials used in backup cooling devices that may be present inside the cabinet.

In the embodiment illustrated in FIG. 3, the vacuum insulated panel 12 is located nearer to the outer wall 62 than to the inner wall 60. This is preferable because the greater temperature gradiant is generally present nearer to the outer wall, and therefore it is desirable to locate the most effective insulator, i.e., the vacuum insulated panel 12, nearer the outer wall. However, it is also generally preferable to have some foam insulation 64 present between the vacuum insulated panel 12 and the outer wall 62, because the presence of the foam insulation 64 in this region provides some sound deadening and structural benefits as opposed to having the vacuum insulated panel 12 abutting directly against the outer wall 62.

A side wall according to the embodiment of FIG. 3 is preferably constructed in the following manner. First, an array of vacuum insulating panels is taped together abutting each other edge to edge in a size corresponding to the size of the side wall. The taped together array may feature a single port hole 14 such as shown in panel 12 in FIG. 1, and/or may feature one or more indentation regions 26 or 34, indentation regions 44 and 54, and one or more indentation regions 56. The panels are taped together, with the tape being omitted or removed where an aperture is desired.

When the desired array has been constructed, it is placed generally against the inside of the outer wall of the cabinet, and the array may be blocked in place by preformed solid foam blocks and adhesives. Once the vacuum insulated panel array has been placed in each desired side wall of the outer cabinet, and blocked in place with the proper spacing from the outer side wall, the inner chamber wall structure is inserted inside the housing. The two housings are then substantially sealed together and polyurethane foam insulation is injected under pressure into the space between the outer housing and the inner chamber wall in such a way as to substantially or completely fill the entire space therebetween. The resulting composite structure can be made much thinner than an insulation structure with foam alone, providing a unit with a smaller floor plan than would otherwise be required.

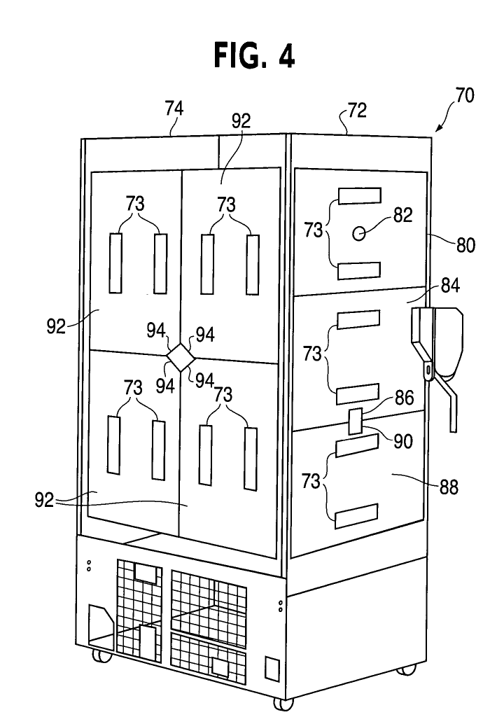

FIG. 4 is perspective layout view of a freezer unit 70 using a vacuum insulated panel array in each of the three side walls of the unit. Foam blocks 73 are shown which are used to locate the panels during assembly of the unit. By way of example only, a side wall 72 with a panel 80 has a port hole 82, a panel 84 has a indented region 86 and a panel 88 has an indented region 90. Thus, provision for two passageways (one at 82, the other at 86 and 90) is provided in a side 72 of the cabinet.

The rear wall 74 of the refrigerator 70 has an array of four vacuum insulated panels 92, each having a beveled corner 94 which together form a square passageway. In this example, a single passageway is provided in the rear 74 of the cabinet.

The arrangement illustrated in FIG. 4 thus provides the ability for penetration of the unit through the side walls that have vacuum insulated panels. Without this feature, using only rectangular prior art panels, such penetration would need to be accomplished in a wall that does not have vacuum insulated panels, or the panels would need to be sized smaller than the wall, or be spaced apart from each other to provide a passageway.

The present invention is an improvement by providing in some cases, insulation if desired across nearly all of the entire side wall, with only an aperture area not having vacuum insulation. In this way, embodiments of the present invention can leave a greater ratio of vacuum insulated panel area to a side wall area then was possible with the prior art panels. One consequence of the prior art panels, was that if there was a wall of the unit which was not insulated with vacuum insulated panels, such as the top, bottom or door of the unit, this is the area of the unit that would be provided with passageways. However, the top and bottom of the unit for example may not always be the most location for passageways. In fact, often times it is desirable that the passageways be provided at roughly eye shoulder or waist level, and that they be for example in a rear wall, since this is a convenient location for the wires and conduits to be routed. Thus, the present invention can provide many practical benefits.

The exemplary panels 12, 32, 42 and 52 illustrated in FIG. 1, as well as the exemplary panels 80, 84, 88 and 92 illustrated in FIG. 4, are intended merely to show some possible arrangements. A single panel may be manufactured according to embodiments in this invention with or without any one or more of the port hole and/or edge indentation features that are illustrated. For example, a panel may have a rectangular outline and one, two or more port holes. A panel with a port hole may or may not have indentation edge feature, and if an indentation edge feature is present, it may be a shoulder indentation feature, a semi-circular indentation feature, or an indentation feature having another shape such as a triangle or otherwise. A panel may be constructed with solely a bevel such as bevel 56, or a panel with a bevel 56 may also be provided with a port hole 14 and/or an indentation feature. It will be appreciated that any combination of any one or more of the features shown in FIG. 1 can be used. Moreover, these features are not limited to the specific shape shown, but can be other features that provide a deviation from the prior art solid rectangular design.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A vacuum insulated panel, comprising:
a core having a perimeter and an aperture extending through the core; and
a film envelope surrounding the core having a hole located adjacent the aperture of the core, the envelope being sealed around the aperture of the core.

2. The vacuum insulated panel according to claim 1, wherein the envelope comprises two sheets sealed together around the periphery of the core and sealed around the aperture of the core.

3. A vacuum insulated panel, comprising:
supporting means having a perimeter and an aperture extending through the supporting means;
means for surrounding the core having a hole located adjacent the aperture of the supporting means; and
means for sealing the surrounding means around the supporting means.

4. The vacuum insulated panel according to claim 3, wherein the surrounding means comprises two sheets sealed together around the periphery of the core and sealed around the aperture of the core.

5. An insulating method, comprising:
providing a core having a perimeter and an aperture extending through the core; and
surrounding the core with a film envelope having a hole located adjacent the aperture of the core.

6. The method according to claim 5, wherein the envelope comprises two sheets sealed together around the periphery of the core and sealed around the aperture of the core.

7. A vacuum insulated panel, comprising:
a core having a substantially rectangular overall perimeter, and a indentation provided on at least one side of the overall perimeter of the core; and
a film envelope surrounding the core having a perimeter including an indentation region.

8. The vacuum insulated panel according to claim 7, wherein the envelope comprises two sheets sealed together around the perimeter of the core.

9. A vacuum insulated panel, comprising:
supporting means having a substantially rectangular overall perimeter, and a indentation provided on at least one side of the generally rectangular outline of the supporting means; and
means for surrounding the core having a perimeter including an indentation region; and
means for sealing the surrounding means around the supporting means.

10. The vacuum insulated panel according to claim 9, wherein the surrounding means comprises two sheets sealed together around the perimeter of the supporting means.

11. An insulating method comprising:
providing a core having a substantially rectangular overall perimeter, and a indentation provided on at least one side of the overall perimeter of the core; and
surrounding the core with an envelope having a perimeter including an indentation region.

12. The method according to claim 11, wherein the envelope comprises two sheets sealed together around the perimeter of the core.

13. A vacuum insulated panel, comprising:
a core having a substantially rectangular overall perimeter and a beveled region forming one corner as a beveled corner; and
an envelope surrounding the core and having a perimeter with a beveled region.

14. A vacuum insulated panel according to claim 13, wherein the envelope comprises two sheets sealed together around the perimeter of the core.

15. A vacuum insulated panel, comprising:
supporting means having a substantially rectangular overall perimeter and a beveled region forming one corner as a beveled corner; and
means for surrounding the core having a shape including a beveled region.

16. A vacuum insulated panel according to claim 15, wherein the envelope comprises two sheets sealed together around the perimeter of the core.

17. An insulating method comprising:
provide a core having a substantially rectangular overall perimeter and a beveled region forming one corner as a beveled corner; and
surrounding the core with an envelope having a perimeter with a beveled region.

18. The method according to claim 17, wherein the envelope comprises two sheets sealed together around the perimeter of the core.

19. A freezer cabinet comprising:
an inner chamber wall;
an outer housing wall; and
at least one vacuum insulated panel disposed between the inner wall and the outer wall having an aperture extending therethrough.

20. A freezer cabinet comprising:
an inner chamber wall;
an outer chamber wall; and
at least one vacuum insulated panel disposed between the inner wall and the outer wall having an indentation on one side of the panel.
